(19) United States
(12) Patent Application Publication
(10) Pub. No.: US 2026/0091596 A1
(43) Pub. Date: Apr. 2, 2026

(54) PRINTER

(71) Applicant: Roland DG Corporation, Hamamatsu-shi (JP)

(72) Inventors: Yuta TATEBAYASHI, Hamamatsu-shi (JP); Kenta SHIMOJIMA, Hamamatsu-shi (JP); Takeshi YAGI, Hamamatsu-shi (JP)

(21) Appl. No.: 19/332,486

(22) Filed: Sep. 18, 2025

(30) Foreign Application Priority Data
Sep. 27, 2024 (JP) 2024-169114

(51) Int. Cl. B41J 11/00; B41J 11/06; B41J 11/14; B41J 25/00

(52) U.S. Cl. CPC B41J 11/00212; B41J 11/00218; B41J 11/008; B41J 11/06; B41J 11/14; B41J 25/005

(57) ABSTRACT

A printer includes a sub-scanning mover to execute a sub-scanning operation to move a placement table from an upstream side toward a downstream side in a sub-scanning direction, a main scanning mover to execute a main scanning operation to move at least one of a head or a light irradiator in a main scanning direction, and a controller configured or programmed to control a normal mode in which the main scanning operation and the sub-scanning operation are alternately executed, the main scanning operation being an operation to emit the light, with a first region of the light irradiator being lit, the first region being located downstream of an upstream end of the nozzle row in the sub-scanning direction, and cause a main scanning operation for irradiation to be executed after completion of a last sub-scanning operation in the normal mode.

### CROSS REFERENCE TO RELATED APPLICATIONS

This application claims the benefit of priority to Japanese Patent Application No. 2024-169114 filed on Sep. 27, 2024. The entire contents of this application are hereby incorporated herein by reference.

### BACKGROUND OF THE INVENTION

### 1. Field of the Invention

The present disclosure relates to printers.

### 2. Description of the Related Art

Japanese Patent No. 7175131 discloses a printer that alternately executes a pass operation and a transport operation. In the pass operation, a head ejects a photocurable ink while moving in a scanning direction, and a non-printing-region irradiating portion located downstream of a downstream end of a nozzle row being lit to emit light. In the transport operation, a long medium such as roll paper is transported in the direction of transport. In this printing method, an insufficiently irradiated region is generated after all dots are formed on the medium. Accordingly, such a technique is disclosed that a lighting range is changed to the upstream side relative to a region lit in a previous pass, by a medium transport length corresponding to one single transport operation, without transporting the medium, so that the insufficiently irradiated region is irradiated with the light.

### SUMMARY OF THE INVENTION

Some printers alternately execute an operation of ejecting an ink while moving a head and a light irradiator in a main scanning direction and an operation to move a placement table at which the medium is to be placed in a sub-scanning direction. Some other printers alternately execute an operation of ejecting the ink while moving the head and the light irradiator in the main scanning direction and an operation to move the head and the light irradiator in the sub-scanning direction with respect to the placement table. In these printers, a travel distance of the placement table (the direction of transport) and a movement distance of the head and the light irradiator in the sub-scanning direction are limited according to the size of a casing. Meanwhile, in the printer that transports the long medium disclosed in an embodiment of Japanese Patent No. 7175131, there is not a limitation on movement of machines in the sub-scanning direction. Thus, the above issue is not described or suggested.

In particular, when the printer is to be downsized, an issue arises such that, since the movement distances of the placement table and the like are further limited, the placement table and the like cannot move even when a non-irradiated region that has not faced the light irradiator remains. Thus, there is room for improvement in a method of completing curing of an entire image in such a printer that has the limitation on the movement of members in the sub-scanning direction as such.

Example embodiments of the present invention provided printers each capable of completing curing of an entire image while achieving miniaturization even when there is a limitation on movement of a member such as a placement table in a sub-scanning direction.

An example embodiment of the present disclosure provides a printer including a placement table at which a medium is to be placed, a head including a nozzle row that includes a plurality of nozzles from which an ink is to be ejected toward the medium, the plurality of nozzles being aligned in a sub-scanning direction, a light irradiator to emit light, a sub-scanning mover to execute a sub-scanning operation to move the placement table from an upstream side toward a downstream side in the sub-scanning direction, a main scanning mover to execute a main scanning operation to move at least one of the head or the light irradiator in a main scanning direction intersecting the sub-scanning direction, and a controller configured or programmed to control a normal mode in which the main scanning operation and the sub-scanning operation are alternately executed, the main scanning operation being an operation to emit the light, with a first region of the light irradiator being lit, the first region being located downstream of an upstream end of the nozzle row in the sub-scanning direction, and cause a main scanning operation for irradiation to be executed after completion of a last sub-scanning operation in the normal mode, the main scanning operation for irradiation being an operation to emit the light, with a region of the light irradiator being lit, the region including a second region upstream of the first region in the sub-scanning direction, and an upstream end of a printable range when the placement table is located on a most downstream side being located upstream of an upstream end of the first region, in the sub-scanning direction. According to example embodiments of the present disclosure, it is possible to provide printers each capable of completing curing of an entire image while achieving miniaturization even when there is a limitation on movement of a member, such as a placement table, in a sub-scanning direction.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an explanatory diagram illustrating a configuration of a printer 1.

FIG. 2 is a block diagram of a printing system 80.

FIG. 3 is an explanatory diagram illustrating arrangement of a head 20 and a light irradiator 50.

FIGS. 4A to 4C are explanatory diagrams illustrating a main scanning operation and a sub-scanning operation.

FIG. 5 is an explanatory diagram illustrating an initial mode in a printing method.

FIGS. 6A and 6B are explanatory diagrams illustrating a normal mode.

FIG. 7A is an explanatory diagram illustrating a normal mode, and FIG. 7B is an explanatory diagram illustrating a time when a placement table 2 is located at a limit position Pd.

FIG. 8 is an explanatory diagram illustrating an upstream irradiation mode.

FIGS. 9A and 9B are explanatory diagrams illustrating an upstream irradiation mode.

FIG. 10 is an explanatory diagram illustrating an irradiated region of a light irradiator 50.

FIGS. 11A and 11B are explanatory diagrams illustrating cases with different irradiation intensities of a light irradiator 50.

FIGS. 12A and 12B are explanatory diagrams illustrating modification examples of a first method example.

FIG. 13 is an explanatory diagram illustrating a printing method in a second method example.

FIGS. 14A and 14B are explanatory diagrams illustrating a printing method in a third method example.

FIGS. 15A and 15B are explanatory diagrams illustrating a printer 100 in a second example embodiment of the present invention.

FIG. 16 is a view illustrating a printer 100 in a second example embodiment of the present invention.

### DETAILED DESCRIPTION OF THE EXAMPLE EMBODIMENTS

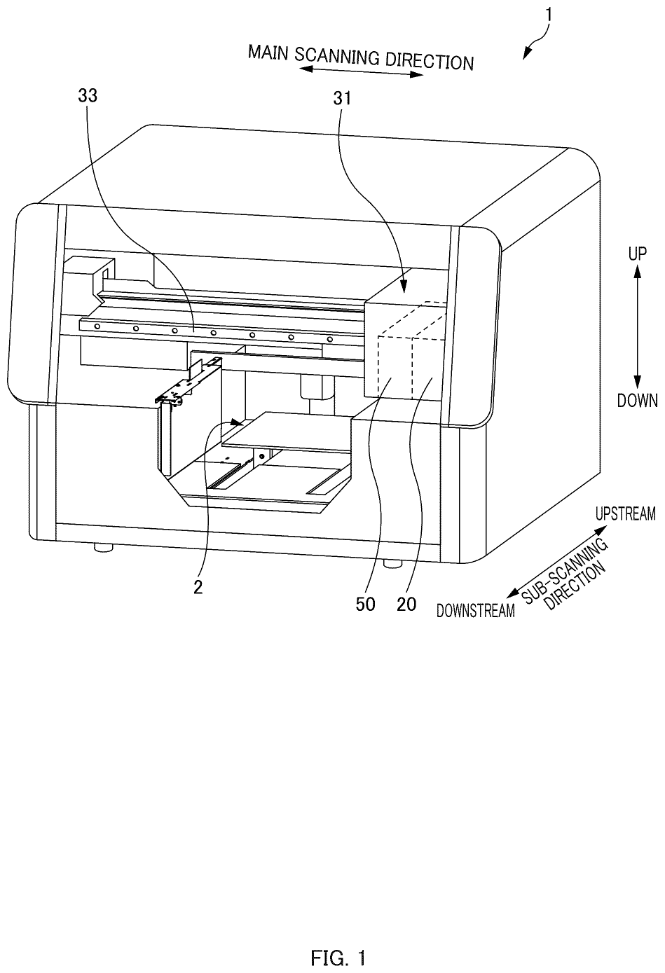

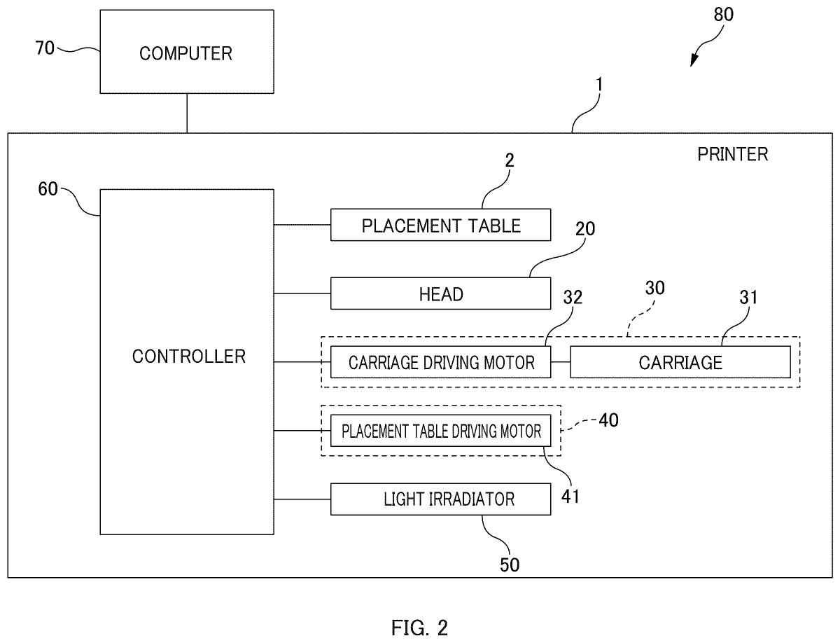

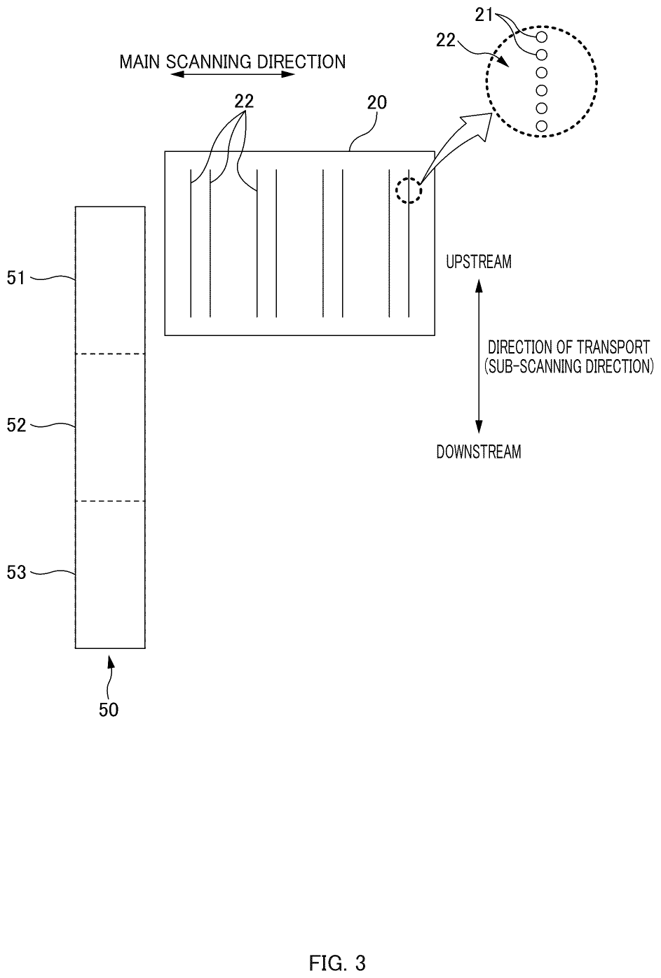

FIG. 1 is an explanatory diagram illustrating a configuration of a printer 1. FIG. 2 is a block diagram of a printing system 80. FIG. 3 is an explanatory diagram illustrating arrangement of a head 20 and a light irradiator 50.

In the following description, a direction of movement of a carriage 31 may be referred to as a “main scanning direction”. In addition, a direction of movement of a medium M may be referred to as a “sub-scanning direction” or a “direction of transport”. The main scanning direction and the sub-scanning direction are mutually intersecting directions (orthogonal directions herein).

The printing system 80 includes the printer 1 and a computer 70. The computer 70 is configured or programmed to control the printer 1, for example, and may be a general-purpose computer in which a print control program is installed. The computer 70 is configured or programmed to generate a command code to control the printer 1, and transmit the command code to the printer 1. However, the printer 1 may implement the function of the computer 70, and thus the printing system 80 may be configured with the printer alone.

The printer 1 ejects an ink onto the medium M. As illustrated in FIG. 2, the printer 1 includes a placement table 2 at which the medium M is to be placed, the head 20, a carriage assembly 30, a placement table driver 40, the light irradiator 50, and a controller 60. The medium M is to be placed on the placement table 2. A type of the medium M is not particularly limited, and examples thereof include cut paper, a film, cloth, and the like.

As illustrated in FIG. 3, the head 20 includes one or more nozzle rows 22 (eight rows in FIG. 3) each including multiple nozzles 21 from which the ink is to be ejected toward the medium M, the multiple nozzles 21 being aligned in the sub-scanning direction. In the drawings of the present application, the nozzle rows 22 that are seen from above the head 20 are illustrated virtually. The head 20 is provided to the carriage 31 and is movable with the carriage 31 in the main scanning direction.

The ink to be ejected from the nozzle 21 is to be cured when being irradiated with light. Examples of the photocurable ink include an ultraviolet curable ink, however, may also include an ink that is cured when irradiated with light having a wavelength other than that. Examples of the ink include color ink (for example, a cyan ink, a magenta ink, a yellow ink, and a black ink) and special ink (for example, a clear ink, a white ink, and a silver ink) used to print an image on the medium M. The clear ink include a gloss ink to control a gloss of the image and a primer ink (a preparatory coating ink) to provide a coating on the medium M.

The carriage assembly 30 includes the carriage 31 and a carriage driving motor 32 that moves the carriage 31 in the main scanning direction. The head 20 and the light irradiator 50 are mounted to the carriage 31. The carriage 31 is guided by a guide rail 33 to be moved in the main scanning direction.

The placement table driver 40 includes a placement table driving motor 41 and moves the placement table 2 in the direction of transport. A driving force of the placement table driving motor 41 is transmitted to the placement table 2 via a transmission mechanism (not illustrated: for example, a feed screw mechanism) to move the placement table 2 in the direction of transport.

The light irradiator 50 emits the light to cure the photocurable ink having ejected from the nozzle 21 and landed at the medium M. For example, an LED lamp that emits ultraviolet rays can be used for the light irradiator 50. The light irradiator 50 is long in the direction of transport as illustrated in FIG. 3, and is longer on a downstream side in the direction of transport than the nozzle rows 22. In addition, the light irradiator 50 is divided into three regions 51 to 53 from an upstream side in the direction of transport, and these regions will also be referred to as an upstream irradiating region 51, an intermediate irradiating region 52, and a downstream irradiating region 53 in this order from the upstream side. With respect to the three regions 51 to 53, control of turning on/off and adjustment of irradiation intensity of the light can be performed individually. Note that the number of the regions obtained by dividing the light irradiator 50 (regions where turning on/off of the light can be controlled) is not limited to three.

In FIG. 3, an upstream end of the light irradiator 50 is shifted on the downstream side relative to upstream ends of the nozzle rows 22. However, the upstream end of the light irradiator 50 may be aligned with the upstream ends of the nozzle rows 22. In addition, the arrangement of the light irradiator 50 is not limited to the light irradiator 50 being provided only on one side of the head 20 in the main scanning direction, but the light irradiators 50 may be provided on both sides of the head 20.

The controller 60 of the printer 1 is configured or programmed to control each portion of the printer 1 based on the command code from the computer 70. For example, the controller 60 may include an arithmetic processor and a storage device (not illustrated). The arithmetic processor executes a program stored in the storage device. The arithmetic processor and the storage device may be electric circuits, for example.

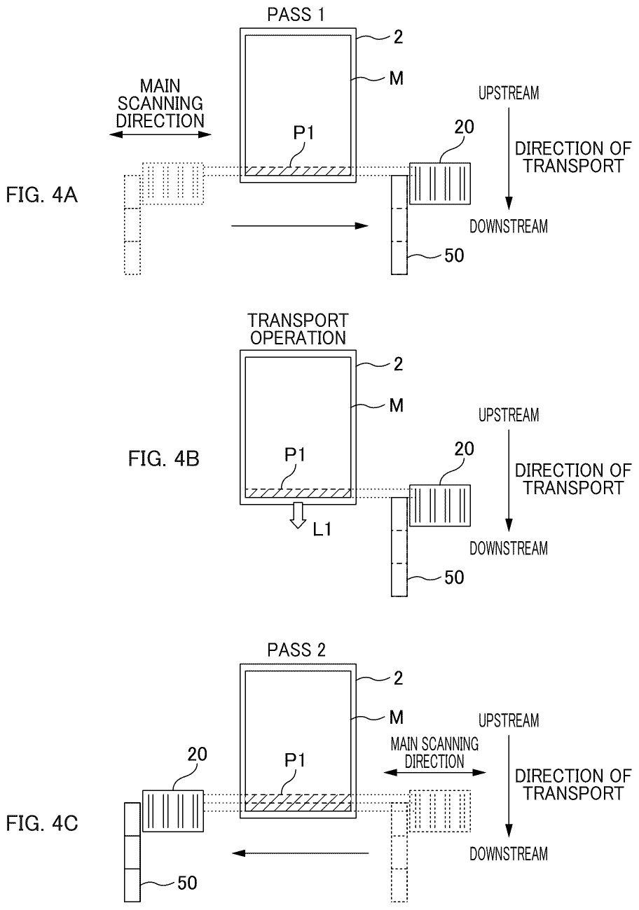

FIGS. 4A to 4C are explanatory diagrams illustrating a main scanning operation and a sub-scanning operation.

The placement table driver 40 (a sub-scanning movement mechanism) described above executes the sub-scanning operation to move the placement table 2 from the upstream side toward the downstream side in the direction of transport. Meanwhile, the carriage assembly 30 (a main scanning movement mechanism) executes the main scanning operation to move the head 20 and the light irradiator 50 in the main scanning direction. In the following description, the sub-scanning operation will also be referred to as a transport operation, the main scanning operation will also be referred to as a pass operation, and the passes will also be numbered (a pass 1, a pass 2, . . . ) in time sequence. The controller 60 of the printer 1 is configured or programmed to perform control such that the placement table driver 40 executes the transport operation, and performs control such that the carriage assembly 30 executes the pass operation.

In an example embodiment of the present disclosure, a case where an image P1 is formed using the ink by the four passes will be described as an example. It is assumed that a movement distance of the placement table 2 in the single transport operation is one-fourth (L1) of the length of the nozzle row 22. However, the method of forming the image P1 using the ink (the number of the passes, and the like) is not particularly limited.

Specifically, as illustrated in FIG. 4A, in the first pass 1, the head 20 ejects the ink toward the medium M facing the head 20 while moving to one way (rightward in FIG. 4A) in the main scanning direction. Next, as illustrated in FIG. 4B, in the transport operation, the placement table 2 is moved downstream in the direction of transport. Next, as illustrated in FIG. 4C, in the pass 2, the head 20 ejects the ink toward the medium M facing the head 20 while moving to the other way (leftward in FIG. 4C) in the main scanning direction. In the region where the ink has been ejected in the pass 1, the ink is ejected from the nozzles 21 that are located more downstream side in the pass 2, than in the pass 1. By alternately repeating the main scanning operation and the transport operation as such, the ink is ejected to a predetermined region in the medium M (for example, the region where the ink is ejected in the pass 1) while facing the head 20 over the four passes to form a portion of the image P1 with the ink. Note that the present disclosure is not limited thereto, but such printing (unidirectional printing) may be adopted in which the head 20 ejects the ink only when moving to one way in the main scanning direction.

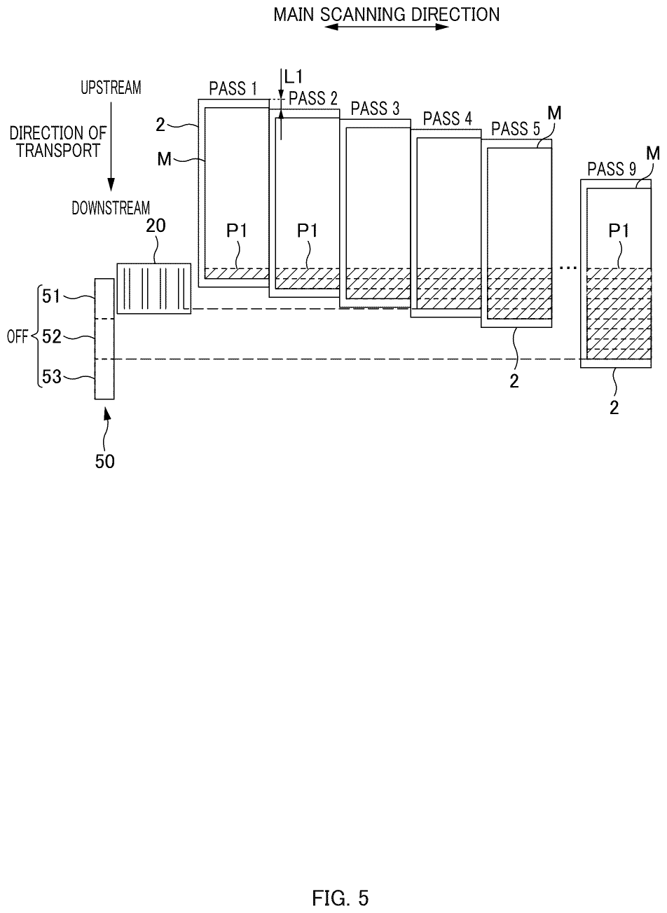

FIG. 5 is an explanatory diagram illustrating an initial mode in a printing method. FIG. 5 illustrates a positional relationship among the head 20, the light irradiator 50, and the placement table 2 in the direction of transport in each of the passes. In the drawings described below, the width of the placement table 2 may be illustrated in half.

The controller 60 of the printer 1 is configured or programmed to execute control in the initial mode at the start of the printing method. In an example embodiment of the present disclosure, the ink on the medium M is cured by using the downstream irradiating region 53, which is located downstream of the nozzle rows 22 in the direction of transport, in the light irradiator 50. In the pass immediately after the start of the printing, the downstream irradiating region 53 does not face the ink on the medium M. Accordingly, in the initial mode, the pass operation is executed in the state where the light in all the regions of the light irradiator 50 including the downstream irradiating region 53 is off.

As the pass operation (FIGS. 4A and 4C) and the transport operation (FIG. 4B) are alternately repeated, the image P1 is formed with the ink on the medium M. In the initial mode, the movement distance L1 of the placement table 2 in the transport operation is constant (herein, one-fourth of the length of the nozzle row 22). As illustrated in FIG. 5, the initial mode is executed up to a pass 9, which is immediately before the region in which the ink is ejected in the pass 1 faces the downstream irradiating region 53 of the light irradiator 50.

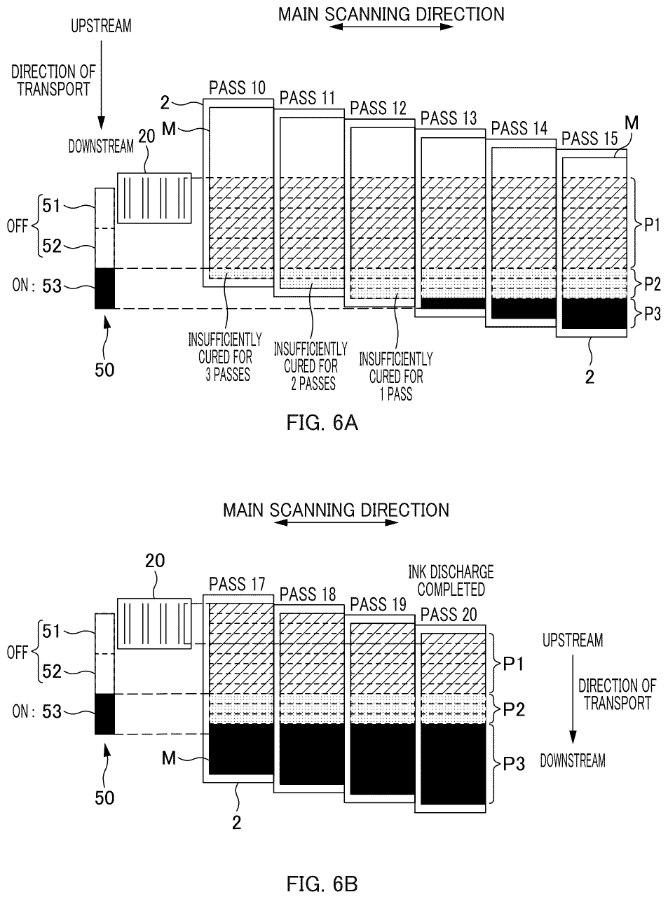

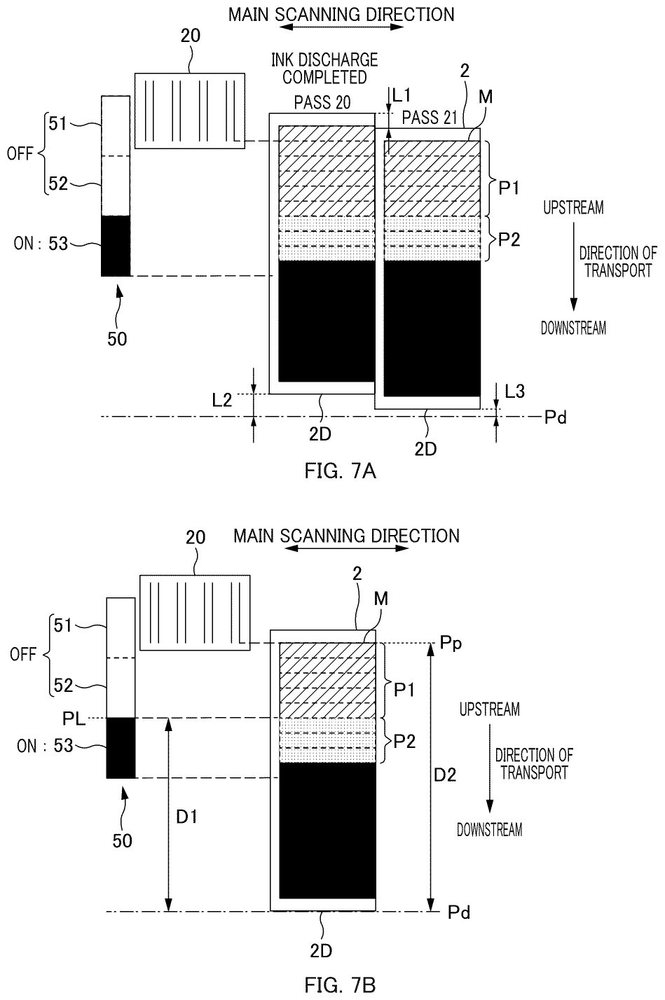

FIGS. 6A, 6B, and 7A are explanatory diagrams illustrating a normal mode. FIG. 7B is an explanatory diagram illustrating a time when the placement table 2 is located at a limit position Pd. The controller 60 of the printer 1 is configured or programmed to execute control in the normal mode after the initial mode. In the normal mode, the controller 60 alternately executes the pass operation in which the downstream irradiating region 53 being lit to emit light, and the transport operation. The movement distance L1 of the placement table 2 in the transport operation is the same as that in the initial mode and is constant.

In an example embodiment of the present disclosure, curing of the ink (photocurable ink) constituting the image P1 is completed in the four passes. Accordingly, the predetermined region (for example, the region where the ink is ejected in the pass 1) of the medium M is irradiated with the light while facing the downstream irradiating region 53 over the four passes, and curing of the ink is thus completed. However, the number of the passes in which the ink is irradiated with the light in the normal mode is not limited to four. In addition, without the execution of the initial mode, the light of the downstream irradiating region 53 may be lit before the ink on the medium M faces the downstream irradiating region 53.

In the following description, a portion (a hatched portion in the drawings) of the image P1 that has not yet faced the downstream irradiating region 53 and has not yet been irradiated with the light will also be referred to as a “non-irradiated region P1”. A portion (a portion with halftone dots) of an image P2 that has faced the downstream irradiating region 53 in the three passes or less and insufficiently irradiated with the light will also be referred to as an “insufficiently irradiated region P2”. A portion (a black portion) of an image P3 that has faced the downstream irradiating region 53 over the four passes, and curing of which is completed, will also be referred to as a “curing completed region P3”.

As illustrated in FIG. 6A, in the case where an upstream region of the medium M face the head 20 (the nozzle rows 22) to form an image even after the start of the normal mode as well, the controller 60 causes a pass operation to be executed in which the downstream irradiating region 53 being lit to apply the light to the ink on the medium M while the ink is being ejected from the nozzles 21. Such a pass operation and the transport operation are alternately repeated up to a pass (a pass 20 in FIG. 6B) in which the ejection of the ink onto the medium M is completed.

In the printer 1, a movable range of the placement table 2 in the direction of transport is set according to the size of a casing. In the following description, the position of a downstream end of the movable range of the placement table 2, that is, the position of a downstream end 2D of the placement table 2 at the time when the placement table 2 is located at the most downstream position will also be referred to as a “limit position Pd”.

As illustrated in FIG. 7A, the controller 60 compares a distance L2, which is a distance in the direction of transport from the downstream end 2D of the placement table 2 to the limit position Pd in the pass 20 in which the ejection of the ink is completed, and the movement distance L1 of the placement table 2 in the transport operation in the normal mode. When the distance L2 is equal to or longer than the movement distance L1 (L2≥L1), the controller 60 causes the sub-scanning operation to be executed even after the pass in which the ejection of the ink is completed, and moves the placement table 2 further downstream. Thereafter, the controller 60 causes a pass 21 to be executed in which the downstream irradiating region 53 being lit to emit light without the ejection of the ink from the nozzles 21.

As such, in the first method example, in the case where the placement table 2 can be moved in the direction of transport even after the ejection of the ink is completed, the normal mode continues in which the sub-scanning operation at the constant movement distance (L1) and the pass operation are alternately executed. That is, the normal mode is executed until the placement table 2 reaches the limit position Pd or a position near the limit position Pd.

Further, the casing of the printer 1 in a first example embodiment is relatively small. Specifically, as illustrated in FIG. 7B, an upstream end Pp of a printable range on the placement table 2 (herein, the medium M on the placement table 2) at the time when the placement table 2 is located on the most downstream side (the limit position Pd) in the direction of transport is located upstream of an upstream end PL of a lighting range (herein, the downstream irradiating region 53) of the light irradiator 50 in the normal mode. In other words, a distance D1 in the direction of transport between the upstream end PL of the lighting range of the light irradiator 50 in the normal mode and the limit position Pd is shorter than a distance D2 in the direction of transport between the upstream end Pp of the printable range at the time when the placement table 2 is located on the most downstream side and the limit position Pd (D1<D2). In this case, the light irradiator 50 is arranged near the limit position Pd in the direction of transport, and thus the printer 1 can be downsized. Here, the size of the medium M matches the size of the printable range on the placement table 2, however, the present disclosure is not limited thereto. The “printable range on the placement table 2” only needs to be the maximum range in which the ink can be caused to land on the placement table 2. When it is possible to cause the ink to land on the entire surface of the placement table 2, the “printable range on the placement table 2” is the same range as that of the entire placement surface of the placement table 2. When it is possible to cause the ink to land in a range that is on the inner side relative to the edge of the placement table 2 by a predetermined distance, the “printable range on the placement table 2” is a range that is on the inner side relative to the edge of the placement table 2 by the predetermined distance. The medium M only needs to be placed within the “printable range on the placement table 2”.

Here, as illustrated in FIG. 7A, in the last pass 21 in the normal mode, the non-irradiated region P1 remains on the medium M even after the downstream irradiating region 53 emits the light in a state where the placement table 2 reaches the limit position Pd or a position near the limit position Pd. Even when the non-irradiated region P1 remains, the placement table 2 can no longer be moved downstream (cannot be moved for a distance equal to or longer than the movement distance L1 in the normal mode), and thus the non-irradiated region P1 cannot face the downstream irradiating region 53.

Thus, the controller 60 shifts the mode from the normal mode to an upstream irradiation mode.

The present disclosure is not limited to the case where the region of the light irradiator 50 positioned downstream of the nozzle rows 22 is lit as in an example embodiment of the present disclosure. For example, there are printers that are configured to execute the normal mode such that the ink is ejected using an upstream half of the nozzle rows and the light irradiator overlapping a downstream half of the nozzle rows in the direction of transport is lit. In such a case, in a pass in which the ejection of the ink is completed using the upstream half of the nozzle rows, when the placement table reaches the limit position or the position near the limit position, the non-irradiated region remains.

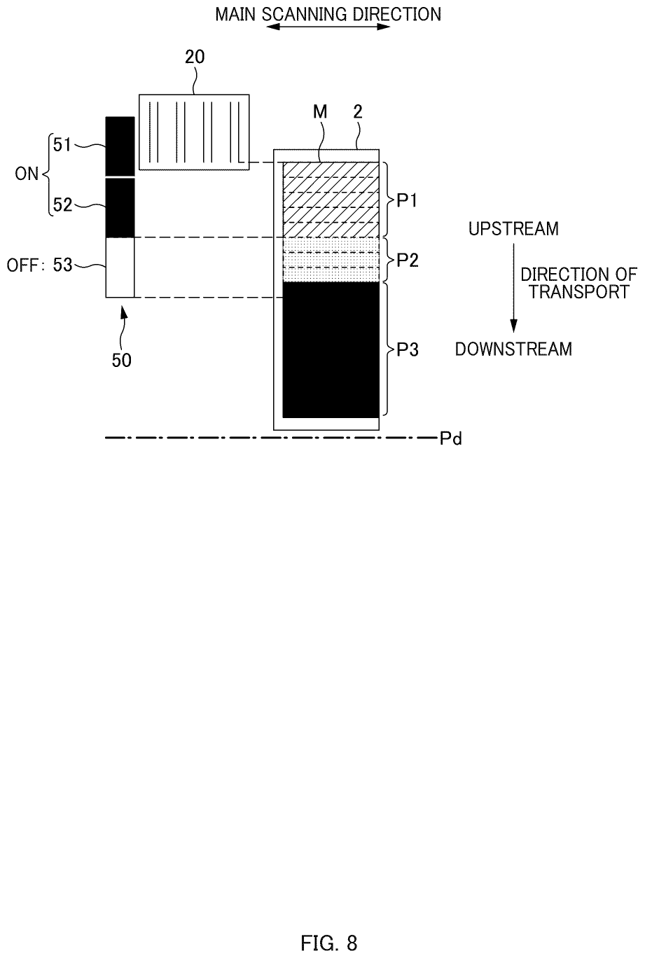

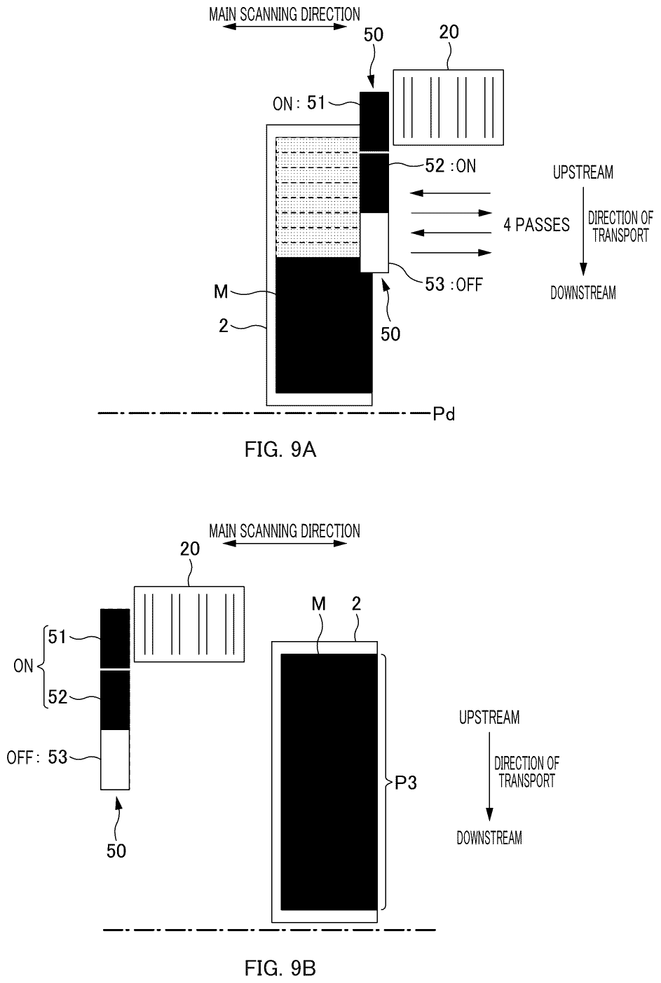

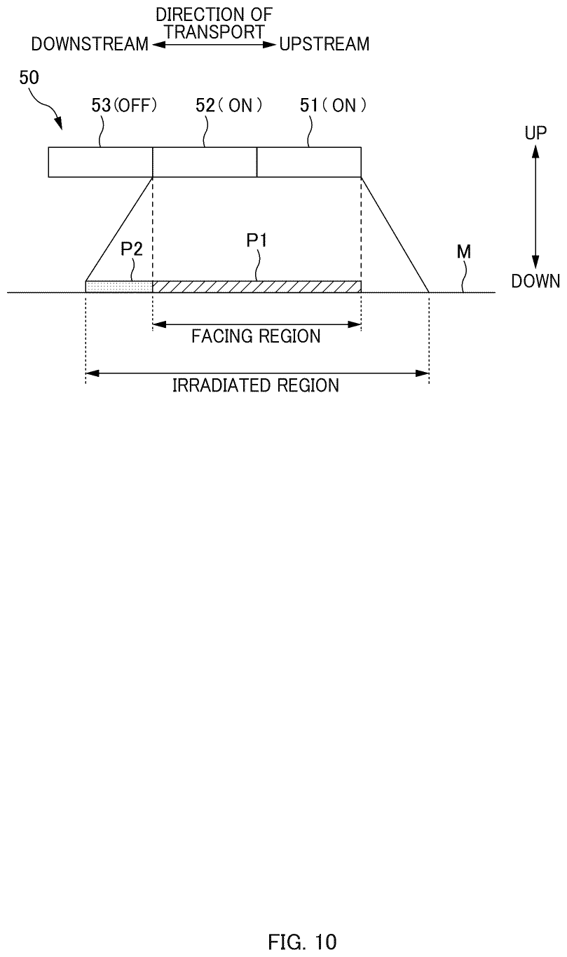

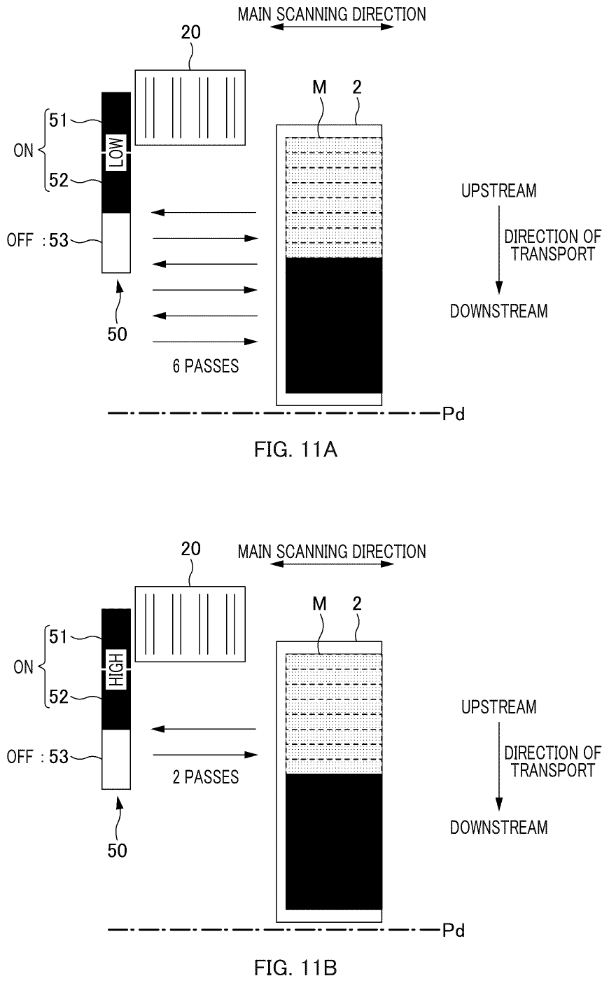

FIGS. 8, 9A, and 9B are explanatory diagrams illustrating the upstream irradiation mode. FIG. 10 is an explanatory diagram illustrating the irradiated region of the light irradiator 50. FIGS. 11A and 11B are explanatory diagrams illustrating a case where irradiation intensity of the light irradiator 50 differs. In the upstream irradiation mode, the controller 60 causes a pass (a main scanning operation for irradiation) to be executed in which the light irradiator 50 including the region upstream of the downstream irradiating region 53 in the direction of transport being lit to emit the light. In the first method example, as illustrated in FIG. 8, the pass is executed in which the downstream irradiating region 53 being turned off, and the upstream irradiating region 51 and the intermediate irradiating region 52 that are upstream of the downstream irradiating region 53 being lit. Note that, in the case of such a configuration in which the head 20 and the light irradiator 50 are individually movable in the main scanning direction, only the light irradiator 50 may be moved without moving the head 20 in the upstream irradiation mode.

In addition, in the upstream irradiation mode, a pass is executed in a state of maintaining the position of the placement table 2 at the time of the completion of the last transport operation (the transport operation between the pass 20 and the pass 21 in FIG. 7A) in the normal mode. That is, in the case of the first method example, the transport operation is not executed after the placement table 2 is moved to the limit position Pd or the position near the limit position Pd, and, as illustrated in FIG. 9A, the head 20 and the light irradiator 50 are moved on the placement table 2 in the main scanning direction once or more (herein four times), and applies the light to the ink on the medium M. In this way, the curing of the ink in the non-irradiated region P1 is completed.

As illustrated in FIG. 8, upon completion of the normal mode, the non-irradiated region P1 and the insufficiently irradiated region P2 remain on the medium M. In the first method example, the region of the light irradiator 50 facing the non-irradiated region P1, that is, the region of the light irradiator 50 overlapping the non-irradiated region P1 in the direction of transport is lit. In FIG. 8, upstream irradiating region 51 and the intermediate irradiating region 52 is lit. Meanwhile, the region of the light irradiator 50 facing the insufficiently irradiated region P2, that is, the region of the light irradiator 50 overlapping the insufficiently irradiated region P2 in the direction of transport is not lit. In FIG. 8, the downstream irradiating region 53 is turned off.

As illustrated in FIG. 10, the light is applied not only onto the region of the medium M facing the lighting region of the light irradiator 50, but also onto surrounding regions thereof. Accordingly, although not facing the upstream irradiating region 51 and the intermediate irradiating region 52, the insufficiently irradiated region P2 is irradiated with the light. As compared to the region facing the lighting region of the light irradiator 50, the amount of the light applied onto the surrounding regions decreases, however, since the light is applied onto the insufficiently irradiated region P2 in at least one pass or more in the normal mode, curing of the ink in the insufficiently irradiated region P2 can be completed. Thus, in the upstream irradiation mode, as illustrated in FIG. 9B, curing of the entire image with the ink ejected onto the medium M is completed.

In the light irradiator 50, there is a case where not only control of turning on/off of the light but also adjustment of the irradiation intensity (unit: mW/cm²) can be executed for each of the divided irradiating regions. Specifically, the output (irradiation intensity) of the lamp can be adjusted by changing a duty ratio of Pulse Width Modulation (PWM) control. In this case, the controller 60 may cause the irradiation intensity per unit area of the lighting range of the light irradiator 50 (for example, an opening region for exposing the lamp in a lower surface of the light irradiator 50) to be the same or different between in the normal mode and in the upstream irradiation mode.

For example, it is assumed that the controller 60 controls the irradiation intensity per unit area of each of the upstream irradiating region 51 and the intermediate irradiating region 52 in the upstream irradiation mode so as to be the same as the irradiation intensity per unit area of the downstream irradiating region 53 in the normal mode. In this case, as illustrated in FIG. 9A, the number of the passes in the upstream irradiation mode may be set to four passes, which is the same as the number of the passes in which curing of the image is completed in the normal mode. This makes it possible to complete the curing of the non-irradiated region P1 and the insufficiently irradiated region P2 in the upstream irradiation mode as well, similarly to the image whose curing is completed in the normal mode.

The present disclosure is not limited to the above, and as illustrated in FIG. 11A, the controller 60 may be configured or programmed to control the irradiation intensity per unit area of each of the upstream irradiating region 51 and the intermediate irradiating region 52 in the upstream irradiation mode so as to be lower than the irradiation intensity per unit area of the downstream irradiating region 53 in the normal mode. In this case, the number of the passes in the upstream irradiation mode may be set to be greater (for example, six passes) than the number of the passes (four passes) in which curing of the image is completed in the normal mode.

In the normal mode, the non-irradiated region P1 is irradiated with the light while facing the downstream irradiating region 53, with respect to each region with a length L1 in the transport operation. Meanwhile, in the upstream irradiation mode (FIG. 9A), the entire non-irradiated region P1 is irradiated with the light all at once in the same pass. In a downstream region of the non-irradiated region P1, since a relatively long time is secured for the time from when the ink lands at the medium M to when it is irradiated with the light, curing of the downstream region starts in a state where dots are spread. On the contrary, in an upstream region of the non-irradiated region P1, since the time from when the ink lands at the medium M to when it is irradiated with the light is short, curing of the upstream region starts in a state where diameters of the dots are small. As such, in the case where the dots are spread differently depending on the regions on the medium M, the image may be streaked due to a minute difference in image quality.

Accordingly, in the upstream irradiation mode (FIG. 11A), the downstream region of the non-irradiated region P1 is irradiated with the light having a low irradiation intensity with the increased number of the passes (by taking a longer time), thus being cured while the spread of the dots is appropriately reduced or prevented. Meanwhile, the upstream region of the non-irradiated region P1 is cured while the dots are spreading. This makes it possible to reduce the difference in the degree of spread of the dots. This makes it also possible to reduce the difference in the image quality between the region (P3) whose curing is completed in the normal mode and the regions (P1, P2) whose curing is completed in the upstream irradiation mode, while reducing the difference in the image quality within the non-irradiated region P1. Thus, the image is less likely to be streaked, and print quality is improved.

Contrary to the above, as illustrated in FIG. 11B, the controller 60 may be configured or programmed to control the irradiation intensity per unit area of each of the upstream irradiating region 51 and the intermediate irradiating region 52 in the upstream irradiation mode so as to be higher than the irradiation intensity per unit area of the downstream irradiating region 53 in the normal mode. In this case, the number of the passes in the upstream irradiation mode may be less (for example, two passes or the like) than the number of the passes (four passes) in which curing of the image is completed in the normal mode. This makes it possible to reduce the time in the upstream irradiation mode to thus reduce an overall print processing time.

Any of the settings of the irradiation intensity described above (FIGS. 9, 11A, and 11B) may be fixed in the printer 1, or the controller 60 may appropriately change the setting of the irradiation intensity described above (for example, according to a print mode). For example, when a high quality mode is set, the irradiation intensity may be reduced (FIG. 11A). When a high-speed print mode is set, the irradiation intensity may be increased (FIG. 11B). When a normal print mode is set, the same irradiation intensity may be set (FIG. 9A).

It is assumed hereinabove that the number of the passes is changed according to the irradiation intensity in the upstream irradiation mode. However, the present disclosure is not limited thereto. In contrast, the controller 60 may be configured or programmed to change the irradiation intensity according to the number of the passes in the upstream irradiation mode. The controller 60 can be configured or programmed to change the number of the passes in the upstream irradiation mode according to the print mode (whether it is the high quality mode or the high-speed print mode), for example. In this case, when there is the large number of the passes in which the predetermined region (for example, the non-irradiated region P1) on the medium M faces the light irradiator 50 (for example, in a case of six passes in FIG. 11A), the irradiation intensity of the light of the upstream irradiating region 51 and the intermediate irradiating region 52 may be reduced. On the contrary, when there is the small number of the passes in which the predetermined region on the medium M faces the light irradiator 50 (for example, in a case of two passes in FIG. 11B), the controller 60 may be configured or programmed to increase the irradiation intensities of the light of the upstream irradiating region 51 and the intermediate irradiating region 52.

In the upstream irradiation mode, the transport operation is not executed between the passes. Thus, the controller 60 may be configured or programmed to execute control of whether to provide a standby time between the passes in the upstream irradiation mode. For example, the controller 60 may be configured or programmed to control such that the next pass is executed after the standby time of a predetermined time (for example, a time needed for the transport operation in the normal mode) has elapsed since the completion of a certain pass. Accordingly, the dots of the ink are spreading during the standby time, and thus the smooth image can be formed. In addition, irradiation conditions in the normal mode and the upstream irradiation mode can be made close to each other, and a boundary between the images formed in the respective modes results in being less noticeable. On the contrary, the controller 60 may be configured or programmed to control such that the next pass is executed after the completion of the certain pass without providing the standby time. In this case, the time in the upstream irradiation mode decreases to thus reduce the overall print processing time.

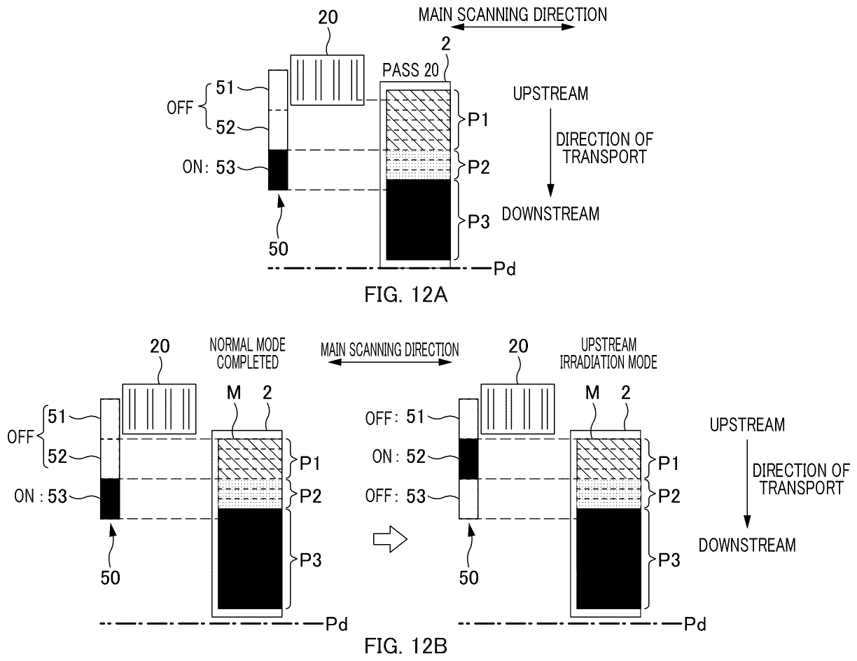

FIGS. 12A and 12B are explanatory diagrams illustrating modification examples of the first method example. In the normal mode described above (FIG. 7A), after the pass 20 in which the ejection of the ink is completed, the transport operation is executed, and then the pass 21 in which the downstream irradiating region 53 emits the light without the ejection of the ink is executed. However, the present disclosure is not limited thereto. For example, as illustrated in FIG. 12A, there is a case where the position of the placement table 2 is the limit position Pd or the position near the limit position Pd in the pass 20 in which the ejection of the ink is completed. That is, there is a case where the distance in the direction of transport between the downstream end of the placement table 2 in the pass 20 and the limit position Pd is shorter than the movement distance L1 in the transport operation. In this case, in the normal mode of the first method example, without executing the pass in which the downstream irradiating region 53 being lit to emit the light without the ejection of the ink from the nozzles 21, the mode is shifted to the upstream irradiation mode.

Further, in the upstream irradiation mode (FIG. 8) described above, the controller 60 turns on the light of the upstream irradiating region 51 and the intermediate irradiating region 52. However, the present disclosure is not limited thereto. For example, as illustrated in the left portion of FIG. 12B, there is a case where the non-irradiated region P1 upon completion of the normal mode does not face the upstream irradiating region 51 and only faces the intermediate irradiating region 52. In this case, as illustrated in the right portion of FIG. 12B, the controller 60 may be configured or programmed to perform control such that a pass in which only the intermediate irradiating region 52 is lit is executed in the upstream irradiation mode.

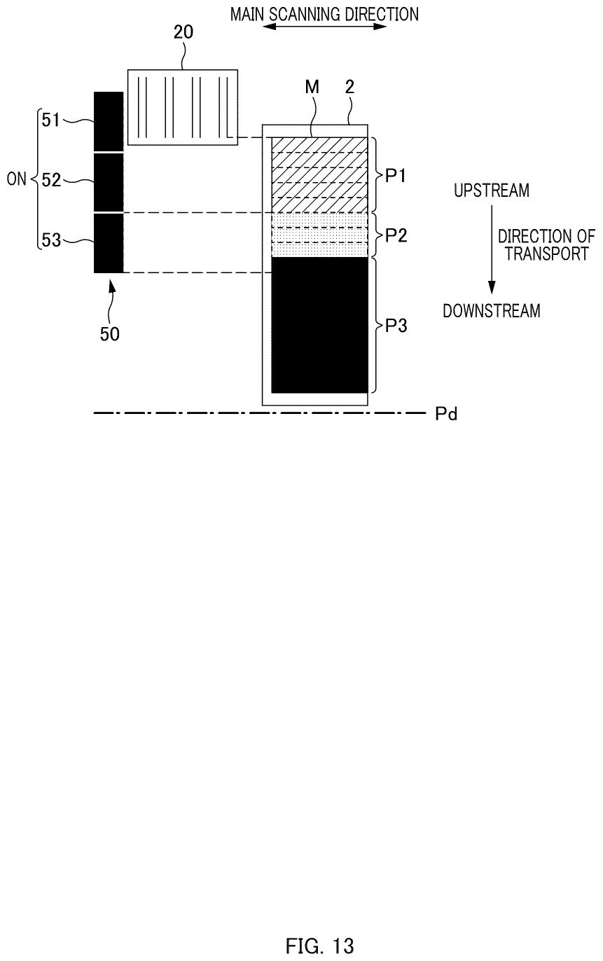

FIG. 13 is an explanatory diagram illustrating a printing method in a second method example. In the upstream irradiation mode of the second method example, the regions of the light irradiator 50 (the upstream irradiating region 51 and the intermediate irradiating region 52 in FIG. 13) facing the non-irradiated region P1 is lit, and the region of the light irradiator 50 (the downstream irradiating region 53 in FIG. 13) facing the insufficiently irradiated region P2 is lit as well, to execute the pass. Accordingly, the ink in the insufficiently irradiated region P2 are reliably irradiated with the light, and thus the entire image can be reliably cured.

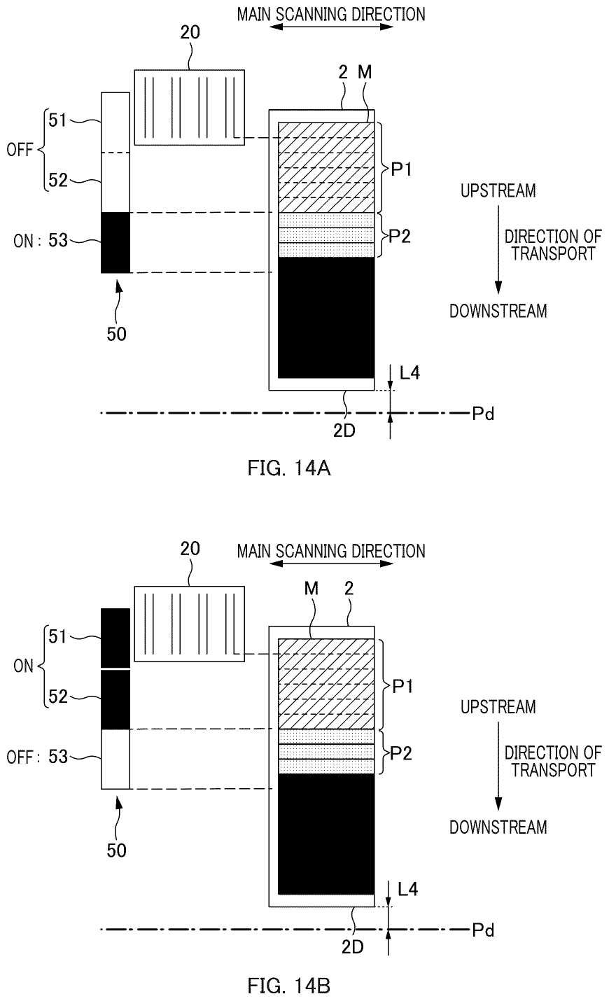

FIGS. 14A and 14B are explanatory diagrams illustrating a printing method in a third method example. In the third method example, the normal mode is completed before the placement table 2 is moved to the limit position Pd or the position near the limit position Pd. That is, even in the case where a distance L4 in the direction of transport between the downstream end 2D of the placement table 2 and the limit position Pd is equal to or longer than the movement distance L1 in the transport operation (L4≥L1), the normal mode is completed.

For example, as illustrated in FIG. 14A, the normal mode may be completed in the pass in which the ejection of the ink is completed. Further, although not illustrated, it is possible to reduce the non-irradiated region P1 by executing the transport operation and the pass operation in which the light is emitted without the ejection of the ink after the completion of the ejection of the ink. Accordingly, the normal mode may be completed at the timing at which the lighting range can be reduced in the upstream irradiation mode, for example, the timing at which the non-irradiated region P1 is shifted from a state of facing the upstream irradiating region 51 and the intermediate irradiating region 52 to a state of facing only the intermediate irradiating region 52. In the upstream irradiation mode (FIG. 14B), the entire non-irradiated region P1 is irradiated with the light at once in the same pass. Thus, when the normal mode is completed at early timing, the entire print processing time can be reduced.

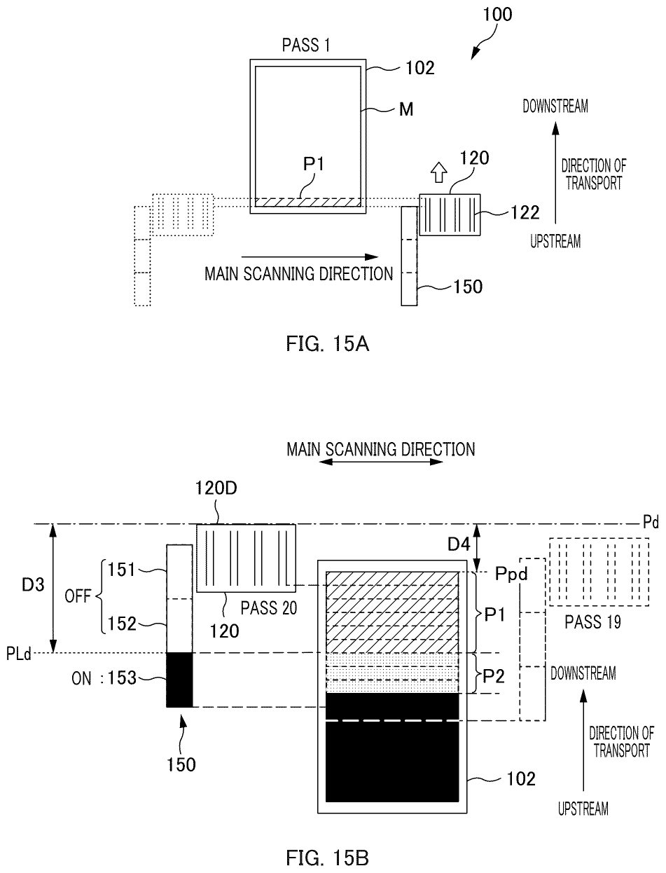

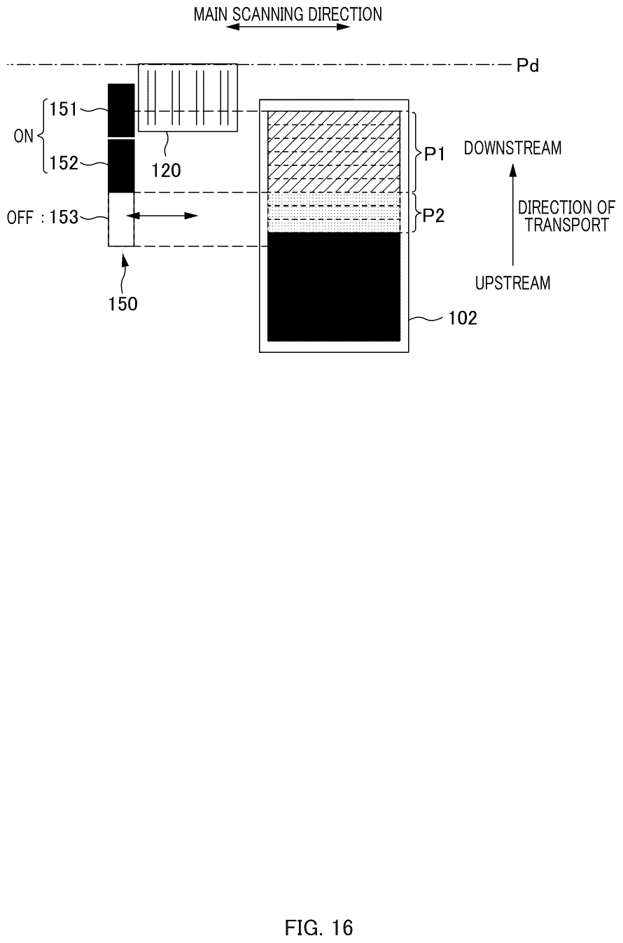

FIGS. 15A, 15B, and 16 are explanatory diagrams illustrating a printer 100 in a second example embodiment. In the printer 100 of the second example embodiment, not a placement table 102 but a head 120 and a light irradiator 150 are moved from the upstream side to the downstream side in the direction of transport, in the transport operation. The main scanning operation is the same as that in the first example embodiment. The head 120 and the light irradiator 150 respectively eject the ink and emit the light while being moved in the main scanning direction. Further, in the light irradiator 150, turning on/off of the light can be controlled with respect to each of three regions (a downstream irradiating region 151, an intermediate irradiating region 152, and an upstream irradiating region 153) obtained by dividing the light irradiator 150 into three in the direction of transport.

In a case of the printer 100 in the second example embodiment, movable ranges of the head 120 and the light irradiator 150 in the direction of transport are set according to the size of a casing of the printer 100. FIG. 15B illustrates the limit position Pd, which is a position of the downstream end of the movable range of the head 120.

Accordingly, the same issue as in the first example embodiment occurs, in the normal mode in which the main scanning operation and the transport operation of the head 120 and the light irradiator 150 are alternately executed, the main scanning operation being an operation of lighting the region of the light irradiator 150 (herein the upstream irradiating region 153) located upstream of the downstream ends of the nozzle rows in the direction of transport. That is, when the head 120 and the light irradiator 150 are moved to the limit position Pd or the position near the limit position Pd, the non-irradiated region P1 remains.

Thus, as illustrated in FIG. 16, after the last transport operation in the normal mode is completed, such a pass is executed in which the regions (herein the downstream irradiating region 151 and the intermediate irradiating region 152) of the light irradiator 150 including the regions downstream of the upstream irradiating region 153 being lit to emit the light. Accordingly, the non-irradiated region P1 faces the lighting range of the light irradiator 150, and curing of the entire image can be completed. Note that the insufficiently irradiated region P2 is irradiated with the light from the intermediate irradiating region 152 (see FIG. 10), and curing thereof is completed. However, the upstream irradiating region 153 may be lit in the main scanning operation for irradiation.

The printer 1 in the first example embodiment includes the placement table 2, the head 20, the light irradiator 50, the placement table driver 40 (the sub-scanning movement mechanism) to execute the sub-scanning operation (the transport operation) to move the placement table 2 from the upstream side toward the downstream side in the sub-scanning direction (the direction of transport), the carriage assembly 30 (the main scanning movement mechanism) to execute the main scanning operation (the pass) to move at least one of the head 20 or the light irradiator 50 in the main scanning direction, and the controller 60. The controller 60 is configured or programmed to control the normal mode in which the main scanning operation and the sub-scanning operation are alternately executed, the main scanning operation being an operation of lighting the first region (for example, the downstream irradiating region 53 in FIG. 7A) of the light irradiator 50 to emit light, the first region being located downstream of the upstream ends of the nozzle rows in the sub-scanning direction. The controller 60 is configured or programmed to cause the main scanning operation for irradiation (for example, the pass in the upstream irradiation mode) to be executed after the completion of the last sub-scanning operation in the normal mode, the main scanning operation for irradiation being an operation of lighting the region of the light irradiator 50 to emit light, the region including a second region (for example, the upstream irradiating region 51 and the intermediate irradiating region 52 in FIG. 8) upstream of the first region in the sub-scanning direction. Furthermore, the upstream end Pp (FIG. 7B) of the printable range at the time when the placement table 2 is located on the most downstream side is located upstream of the upstream end PL of the first region (the downstream irradiating region 53), in the sub-scanning direction.

This can narrow the movable range of the placement table 2 in the sub-scanning direction to thus facilitate downsizing of the printer 1. Further, in a case of executing the printing method in which the irradiation with the light is completed in the main scanning operation after the completion of the dot formation, the non-irradiated region P1 may remain when the placement table 2 reaches the limit position Pd on the downstream side or the position near the limit position Pd. Even in such a case, curing of the entire image can be completed by the main scanning operation for irradiation (FIG. 8). That is, there is no need to expand the movable range of the placement table 2 to the downstream side so as to face the first region of the light irradiator 50, and thus the printer 1 can be downsized.

The printer 100 in the second example embodiment includes the placement table 102 at which the medium M is to be placed, the head 120 including the nozzle rows 122 each including the multiple nozzles from which the ink is to be ejected toward the medium M, the multiple nozzles being aligned in the sub-scanning direction (the direction of transport), the light irradiator 150 to emit the light, the sub-scanning movement mechanism (not illustrated) to execute the sub-scanning operation (the transport operation) to move the head 120 and the light irradiator 150 from the upstream side toward the downstream side in the direction of transport, the main scanning movement mechanism (not illustrated) to execute the main scanning operation to move at least one of the head 120 or the light irradiator 150 in the main scanning direction, and the controller (not illustrated). The controller is configured or programmed to control the normal mode in which the main scanning operation and the sub-scanning operation are alternately executed, the main scanning operation being an operation of lighting the first region (for example, the upstream irradiating region 153 in FIG. 15B) of the light irradiator 150 to emit light, the first region being located upstream of the downstream ends of the nozzle rows in the sub-scanning direction. The controller is configured or programmed to cause the main scanning operation for irradiation to be executed after the completion of the last sub-scanning operation in the normal mode, the main scanning operation for irradiation being an operation of lighting the region of the light irradiator 150 to emit light, the region including the second region (for example, the downstream irradiating region 151 and the intermediate irradiating region 152 in FIG. 16) downstream of the first region in the sub-scanning direction. Furthermore, the downstream end Ppd (FIG. 15B) of the printable range on the placement table 102 is located downstream of the downstream end PLd of the first region (the upstream irradiating region 153) at the time when the head 120 and the light irradiator 150 are located on the most downstream side, in the sub-scanning direction. In other words, a distance D4 in the sub-scanning direction (the direction of transport) between the downstream end Ppd of the printable range and the limit position Pd of the head 120 and light irradiator 150 is shorter than a distance D3 in the sub-scanning direction between the downstream end PLd of the first region and the limit position Pd (D4<D3).

This can narrow the movable ranges of the head 120 and the light irradiator 150 with respect to the placement table 102 in the sub-scanning direction, to thus facilitate downsizing of the printer 100. Further, in the case of executing the printing method in which the irradiation with the light is completed in the main scanning operation after the completion of the dot formation, the non-irradiated region P1 may remain when the head 120 and the light irradiator 150 reach the limit position Pd on the downstream side. Even in such a case, curing of the entire image can be completed by the main scanning operation for irradiation (FIG. 16). That is, there is no need to expand the movable ranges of the head 120 and the light irradiator 150 to the downstream side such that the entire printable range on the placement table 2 faces the first region of the light irradiator 150, and thus, the printer 100 can be downsized.

In the printer 1 of the first example embodiment and the printer 100 of the second example embodiment, the lighting ranges of the light irradiators 50, 150 may be changed at any timing as long as such a change is made after the completion of the last sub-scanning operation in the normal mode. For example, in FIG. 7A, the transport operation is executed after the pass 20, and then the pass 21 in which the light of the downstream irradiating region 53 (the first region) is lit is executed, thus completing the normal mode. However, the lighting range of the light irradiator 50 may be changed as in FIG. 8 without executing the pass 21. That is, the normal mode may be completed with the transport operation after the pass 20. Further, for example, the lighting range of the light irradiator 50 may be changed after the pass in which the downstream irradiating region 53 is lit is executed multiple times at the position in the pass 21 in FIG. 7A. In the meantime, the dots in the uncured non-irradiated region P1 can be wet and spread while curing of the insufficiently irradiated region P2 can be completed.

The controller 60 in the first example embodiment is configured or programmed to cause the main scanning operation for irradiation (for example, the pass in the upstream irradiation mode in FIG. 8) to be executed while maintaining the position of the placement table 2 at the time of the completion of the last sub-scanning operation (for example, the transport operation following the pass 20 in FIG. 7A) in the normal mode.

As illustrated in FIG. 16, the controller in the second example embodiment may also be configured or programmed to cause the main scanning operation for irradiation to be executed while maintaining the positions of the head 120 and the light irradiator 150 at the time of the completion of the last sub-scanning operation in the normal mode.

This makes it possible to complete curing of the entire image, even in the case where there is a limitation on movement of the members (the placement table 2, the head 120, and the light irradiator 150) in the sub-scanning direction and the sub-scanning operation cannot be executed after the normal mode. Further, it is possible to reduce the time for the sub-scanning operation, thus being able to reduce the overall print processing time.

However, the present disclosure is not limited to the above. In the case where the placement table 2 and the like can be moved in the sub-scanning direction even after the completion of the normal mode, the sub-scanning operation may be executed during the main scanning operation for irradiation. For example, in the upstream irradiation mode (FIG. 8), only the intermediate irradiating region 52 may be lit, and the region of the non-irradiated region P1 facing the intermediate irradiating region 52 may be cured, and then the sub-scanning operation may be executed, and the remaining region of the non-irradiated region P1 may be caused to face the intermediate irradiating region 52.

The controller 60 in the first example embodiment is configured or programmed to cause the main scanning operation (for example, the pass 21 in FIG. 7A) of lighting the first region to emit light without the ejection of the ink from the nozzles, to be executed, after the main scanning operation (for example, the pass 10 to the pass 20 in FIG. 6) of lighting the first region (the downstream irradiating region 53) to emit light while the ink is being ejected from the nozzles, in the normal mode.

The controller in the second example embodiment may also be configured or programmed to cause the main scanning operation of lighting the first region to emit light without the ejection of the ink from the nozzles, to be executed, in the case where the head 120 and the light irradiator 150 can be moved in the sub-scanning direction, after the main scanning operation (FIG. 15B) of lighting the first region (the upstream irradiating region 153) to emit light while the ink is being ejected from the nozzles, in the normal mode.

Accordingly, the main scanning operation and the sub-scanning operation in the normal mode are alternately executed even after the ejection of the ink is completed, thus being able to cure the ink over a wide range of the image under the same or close irradiation condition, and thus the quality of the entire image can be brought closer to uniformity. Specifically, the image can face the first region every movement distance in the sub-scanning operation, a time interval from when the ink lands at the medium M to when the irradiation is started can be made constant, and the number of the passes to complete curing can be made the same.

The controller 60 in the first example embodiment may be configured or programmed to cause the main scanning operation for irradiation (FIG. 8) to be executed, after the distance L3 from the downstream end 2D of the placement table 2 at the time of the completion of the sub-scanning operation (the transport operation following the pass 20 in FIG. 7A) to the downstream end Pd of the movable range of the placement table 2 in the sub-scanning direction becomes shorter than the movement distance L1 of the placement table 2 in the sub-scanning direction in the normal mode.

The controller in the second example embodiment may also be configured or programmed to cause the main scanning operation for irradiation (FIG. 16) to be executed, after a distance from a downstream end 120D of the head 120 (or the light irradiator 150) at the time of the completion of the certain sub-scanning operation in the normal mode to the downstream end Pd of the movable range of the head 120 (or the light irradiator 150) becomes shorter than the movement distance of the head 120 and light irradiator 150 in the sub-scanning operation in the normal mode.

Accordingly, the main scanning operation and the sub-scanning operation in the normal mode are alternately executed up to a movement limit of the placement table 2 or the head 120 and light irradiator 150 in the sub-scanning direction (until the next sub-scanning operation can no longer be executed), thus being able to cure the ink in the region of the image as large as possible under the same or close irradiation condition, which brings the quality of the entire image closer to uniformity.

The controller 60 of the printer 1 in the first example embodiment is configured or programmed to cause the irradiation intensity per unit area of the lighting range (for example, the downstream irradiating region 53 in FIG. 7A) of the light irradiator 50 in the normal mode to be different from the irradiation intensity per unit area of the lighting range (for example, the upstream irradiating region 51 and the intermediate irradiating region 52 in FIG. 8) of the light irradiator 50 in the main scanning operation for irradiation. The controller of the printer 100 in the second example embodiment may be the same.

This makes it possible to execute curing of the image according to the application. For example, by reducing the irradiation intensity in the main scanning operation for irradiation (FIG. 11A), the dots of the ink shortly after landing at the medium M can be wet and spread without being cured immediately. On the contrary, by increasing the irradiation intensity in the main scanning operation for irradiation (FIG. 11B), curing of the ink can be completed immediately, thus being able to reduce the overall print processing time.

The controller 60 of the printer 1 in the first example embodiment is configured or programmed to reduce the irradiation intensity in the main scanning operation for irradiation (FIG. 11A) to be lower than the irradiation intensity in the normal mode (FIG. 7A). The controller of the printer 100 in the second example embodiment may be the same.

This enables dots of the ink shortly after landing at the medium M, in the ink that is to be cured in the main scanning operation for irradiation, to be wet and spread without being cured immediately, thus being able to reduce the difference in image quality caused by the difference in the spread of the dots. Thus, the quality of the entire image can be brought closer to uniformity, the image is less likely to be streaked, and thus the print quality is improved.

The controller 60 of the printer 1 in the first example embodiment is configured or programmed to reduce the number (for example, twice as illustrated in FIG. 11B) of the main scanning operation for irradiation in which the predetermined region of the medium M faces the light irradiator 50 after the normal mode (in the upstream irradiation mode), to be less than the number (for example, four times as illustrated in FIG. 6) of the main scanning operation in which the predetermined region of the medium M faces the light irradiator 50 in the normal mode. The controller of the printer 100 in the second example embodiment may be the same.

This makes it possible to reduce the overall print processing time by completing the curing of the ink with the reduced number of times of the main scanning operation after the normal mode.

The controller 60 of the printer 1 in the first example embodiment is configured or programmed to change the irradiation intensity per unit area of the lighting range of the light irradiator 50 in the main scanning operation for irradiation, based on the number of the main scanning operations for irradiation in which the predetermined region of the medium M faces the light irradiator 50 after the normal mode. The controller of the printer 100 in the second example embodiment may be the same.

This makes it possible to cure the ink with the irradiation intensity suitable for the number of the main scanning operations for irradiation. For example, in the case where the number of the main scanning operations for irradiation is large as in FIG. 11A, the dots can be wet and spread with the irradiation intensity being reduced, to thus make the quality of the entire image closer to uniformity. In the case where the number of the main scanning operations for irradiation is small as in FIG. 11B, curing of the image can be reliably completed with the irradiation intensity being increased.

The controller 60 of the printer 1 in the first example embodiment is configured or programmed to cause the light of the first region (the downstream irradiating region 53 in FIG. 8) to be off in the main scanning operation for irradiation. The controller of the printer 100 in the second example embodiment may also be configured or programmed to cause the light of the first region (the upstream irradiating region 153 in FIG. 16) to be off in the main scanning operation for irradiation.

This makes it possible to reduce or prevent reflection of light in the casing of the printer 1, 100 and, for example, reduce or prevent curing of the ink adhering to a nozzle surface or the like of the head 20, 120. Further, even when the region facing the first region at the time of the completion of the normal mode is the insufficiently irradiated region P2, the curing thereof can be completed with the light applied from the second region, thus being able to complete the curing of the entire image.

The first region (the downstream irradiating region 53 in FIG. 7) of the printer 1 in the first example embodiment is located downstream of the nozzle rows 22 in the sub-scanning direction. Meanwhile, the first region (the upstream irradiating region 153 in FIG. 15B) of the printer 100 in the second example embodiment is located upstream of the nozzle rows 122 in the sub-scanning direction.

Accordingly, in the normal mode, the pass in which the ink lands at the predetermined region of the medium M differs from the pass in which the light is applied to the ink on the predetermined region. This enables the dots of the ink to be wet and spread during a period of time from when the ink lands at the medium M to when it is irradiated with the light, thus being able to form a smooth image. In particular, in the case where the image is formed by superimposing an image with a clear ink (gloss ink) on an image with a black ink and/or a color ink, and/or the like, the dots of the clear ink are wet, spread, and smoothed, and thus a further glossy image can be formed.

Example embodiments described above are merely proposed as examples, and thus are not intended to limit the scope of the disclosure. Configurations described above can be implemented in any combination, and various omissions, substitutions, and changes can be made thereto within the scope that does not depart from the features of the disclosure.

Example embodiments described above and modifications thereof are included in the scope and the features of the disclosure, and are included in the disclosure described in the claims and equivalents thereof.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A printer comprising:
a placement table at which a medium is to be placed;
a head including a nozzle row that includes a plurality of nozzles from which an ink is to be ejected toward the medium, the plurality of nozzles being aligned in a sub-scanning direction;
a light irradiator to emit light;
a sub-scanning mover to execute a sub-scanning operation to move the placement table from an upstream side toward a downstream side in the sub-scanning direction;
a main scanning mover to execute a main scanning operation to move at least one of the head or the light irradiator in a main scanning direction intersecting the sub-scanning direction; and
a controller configured or programmed to:
control a normal mode in which the main scanning operation and the sub-scanning operation are alternately executed, the main scanning operation being an operation to emit the light, with a first region of the light irradiator being lit, the first region being located downstream of an upstream end of the nozzle row in the sub-scanning direction; and
cause a main scanning operation for irradiation to be executed after completion of a last sub-scanning operation in the normal mode, the main scanning operation for irradiation being an operation to emit the light, with a region of the light irradiator being lit, the region including a second region upstream of the first region in the sub-scanning direction; and
an upstream end of a printable range when the placement table is located on a most downstream side being located upstream of an upstream end of the first region, in the sub-scanning direction.

2. The printer according to claim 1, wherein the controller is configured or programmed to cause the main scanning operation for irradiation to be executed in a state of maintaining a position of the placement table at a time of completion of the last sub-scanning operation in the normal mode.

3. The printer according to claim 1, wherein the controller is configured or programmed to cause the main scanning operation to emit the light with the first region being lit without ejection of the ink from the nozzles, to be executed, after the main scanning operation to emit the light with the first region being lit while the ink is being ejected from the nozzles, in the normal mode.

4. The printer according to claim 1, wherein the controller is configured or programmed to cause the main scanning operation for irradiation to be executed, after a distance from a downstream end of the placement table at a time when a certain sub-scanning operation in the normal mode is completed to a downstream end of a movable range of the placement table becomes shorter than a movement distance of the placement table in the sub-scanning operation in the normal mode, in the sub-scanning direction.

5. The printer according to claim 1, wherein the controller is configured or programmed to cause an irradiation intensity per unit area of a lighting range of the light irradiator in the normal mode to be different from an irradiation intensity per unit area of a lighting range of the light irradiator in the main scanning operation for irradiation.

6. The printer according to claim 5, wherein the controller is configured or programmed to reduce the irradiation intensity in the main scanning operation for irradiation to be lower than the irradiation intensity in the normal mode.

7. The printer according to claim 1, wherein the controller is configured or programmed to reduce the number of the main scanning operations for irradiation in which a predetermined region of the medium faces the light irradiator after the normal mode, to be less than the number of the main scanning operations in which the predetermined region of the medium faces the light irradiator in the normal mode.

8. The printer according to claim 1, wherein the controller is configured or programmed to change an irradiation intensity per unit area of a lighting range of the light irradiator in the main scanning operation for irradiation, based on the number of the main scanning operations for irradiation in which a predetermined region of the medium faces the light irradiator after the normal mode.

9. The printer according to claim 1, wherein the controller is configured or programmed to cause the light of the first region to be off in the main scanning operation for irradiation.

10. The printer according to claim 1, wherein the first region is located downstream of the nozzle row in the sub-scanning direction.

11. A printer comprising:
a placement table at which a medium is to be placed;
a head including a nozzle row that includes a plurality of nozzles from which an ink is to be ejected toward the medium, the plurality of nozzles being aligned in a sub-scanning direction;
a light irradiator to emit light;
a sub-scanning mover to execute a sub-scanning operation to move the head and the light irradiator from an upstream side toward a downstream side in the sub-scanning direction;
a main scanning mover to execute a main scanning operation to move at least one of the head or the light irradiator in a main scanning direction intersecting the sub-scanning direction; and
a controller configured or programmed to:
control a normal mode in which the main scanning operation and the sub-scanning operation are alternately executed, the main scanning operation being an operation to emit the light, with a first region of the light irradiator being lit, the first region being located upstream of a downstream end of the nozzle row in the sub-scanning direction; and
cause a main scanning operation for irradiation to be executed after completion of a last sub-scanning operation in the normal mode, the main scanning operation for irradiation being an operation to emit the light, with a region of the light irradiator being lit, the region including a second region downstream of the first region in the sub-scanning direction; and
a downstream end of a printable range being located downstream of a downstream end of the first region when the head and the light irradiator are located on a most downstream side, in the sub-scanning direction.
